(19) United States
(12) Patent Application Publication
(10) Pub. No.: US 2017/0279986 A1
(43) Pub. Date: Sep. 28, 2017

(54) ELECTRONIC APPARATUS

(71) Applicant: FUJI XEROX CO., LTD., Tokyo (JP)

(72) Inventor: Satoshi TAKAOKA, Yokohama-shi (JP)

(73) Assignee: FUJI XEROX CO., LTD., Tokyo (JP)

(21) Appl. No.: 15/211,564

(22) Filed: Jul. 15, 2016

(30) Foreign Application Priority Data
Mar. 23, 2016 (JP) 2016-059239

(51) Int. Cl. H04N 1/00; H04N 1/32

(52) U.S. Cl. CPC H04N 1/00469; H04N 1/00474; H04N 1/32128

(57) ABSTRACT

An electronic apparatus includes a display, a communication unit and an adjustment unit that adjusts a size of a screen in a case where a file is displayed on the display based on first device information on the display and second device information on displaying the file acquired by the communication unit.

### CROSS-REFERENCE TO RELATED APPLICATIONS

This application is based on and claims priority under 33 USC 119 from Japanese Patent Application No. 2016-059239 filed on Mar. 23, 2016.

### BACKGROUND

### Technical Field

The present invention relates to an electronic apparatus.

### SUMMARY

An object of the invention is to display a screen corresponding to a display screen having a certain size in a display screen having a different size, and to present operatability from being degraded.

An aspect of the invention provides an electronic apparatus, including: a display; a communication unit; and an adjustment unit (that adjusts a size of a screen in a case where a file is displayed on the display based on first device information on the display and second device information on displaying the file acquired by the communication unit.

### BRIEF DESCRIPTION OF THE DRAWINGS

Exemplary embodiments of the invention will be described in detail based on the following figures, wherein:

FIG. 1 is a diagram illustrating an entire configuration of an exemplary embodiment;

FIG. 2 is a diagram illustrating a hardware configuration of a printing device 1;

FIG. 3 is a diagram illustrating a functional configuration of the printing device 1;

FIG. 4 is a diagram illustrating a menu screen;

FIG. 5 is a diagram illustrating a registration screen;

FIG. 6 is a diagram illustrating a setting screen;

FIG. 7 is a diagram illustrating an operation screen;

FIG. 8 is a diagram illustrating a display example in a case where a display position is at the center;

FIG. 9 is a diagram illustrating a display example in a case where the display position is in a left upper portion;

FIG. 10 is a diagram illustrating a display example showing a status of the device;

FIG. 11 is a diagram illustrating a display example of a virtual key;

FIG. 12 is a diagram illustrating an enlarged display example;

FIG. 13 is a diagram illustrating an example where the display position is moved by a drag or flick operation;

FIG. 14 is a diagram illustrating an example where buttons are displayed on a magnified scale;

FIG. 15 is a diagram illustrating another example where the buttons are displayed on a magnified scale;

FIG. 16 is a flowchart illustrating a main routine;

FIG. 17 is a flowchart illustrating a transmission process;

FIG. 18 is a flowchart illustrating a reception process;

FIG. 19 is a flowchart illustrating a display process;

FIG. 20 is a flowchart illustrating a display mode select process;

FIG. 21 is a flowchart illustrating a reduction display process;

FIG. 22 is a flowchart illustrating a magnification display process;

FIG. 23 is a flowchart illustrating a timer process;

FIG. 24 is a flowchart illustrating an operation process;

FIG. 25 is a diagram illustrating a first setting table;

FIG. 26 is a diagram illustrating a second setting table; and

FIG. 27 is a diagram illustrating a management table.

### DETAILED DESCRIPTION

Art exemplary embodiment for implementing the invention will be described.

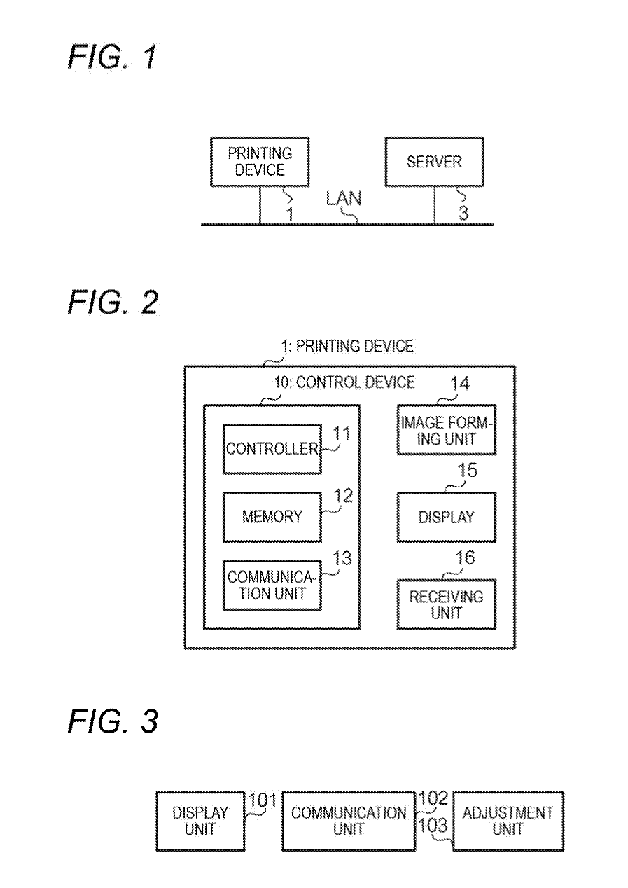

FIG. 1 is a diagram illustrating an entire configuration of the exemplary embodiment. A printing device 1 and a server 3 are connected to a communication unit such as a LAN (Local Area Network).

FIG. 2 is a diagram illustrating a hardware configuration of the printing device 1. The printing device 1 is an example of an electronic apparatus according to an exemplary embodiment of the invention. A control device 10 is provided with a controller 11, a memory 12, and a communication unit 13, and serves to control the printing device 1. The control device 10 is configured as an external apparatus of the printing device 1. The control device 10 may be configured to communicate with the printing device 1 through the communication unit.

The controller 11 includes a calculation device such as a CPU (Central Processing Unit), and a storage device such as a ROM (Read Only-Memory) and a RAM (Random Access Memory). The ROM stores firmware describing a start procedure of the hardware and an OS (Operation System). The RAM is used to store data when the CPU performs calculation. The memory 12 is provided with a hard-disk storage device, for example, and stores the OS or an application program. The communication unit 13 is a communication I/F (interface) which is used to connect the printing device 1.

An image forming unit 14 forms an image in a sheet-shaped recording medium based on raster data through an electrophotographic process or an inkjet process, for example. The recording medium is, for example, a print sheet (hereinafter, referred to as a sheet).

A display 15 is provided with, for example, a liquid crystal display, and displays a GUI (Graphical User Interface) screen so as to operate the printing device 1. A receiving unit 16 is provided with a touch panel to cover a display screen of the display 15 for example, and receives an operation on the printing device 1.

A reading unit 17 is provided with an image scanner for example, and optically reads an original document and outputs an image signal. The stacked documents may be provided with an original document feeder which sends out the stacked documents one by one to a reading position.

A facsimile communication unit 18 is provided with a modem which is connected to a telephone line for example, and transmits and receives image data with respect to a facsimile device.

FIG. 3 is a diagram illustrating a functional configuration of the printing device 1. The printing device 1 is provided with a display unit 101, a communication unit 102, first device information on the display unit 101, second device information on a display of a file acquired by the communication unit 102, and an adjustment unit 103 which adjusts a size of a display in a case where the acquired file is displayed on the display unit 101. Incidentally, the display unit 101 and the communication unit 102 may be implemented by the display 15 and the communication device 13, respectively, and the adjustment unit 103 may be implemented by the control device 10. Alternatively, the adjustment unit 103 may be implemented by the controller 11 executing instructions stored in the memory 12.

Next, an operation of this exemplary embodiment will be described. The controller 11 of the printing device 1 performs the following processes according to an application program installed in the printing device 1.

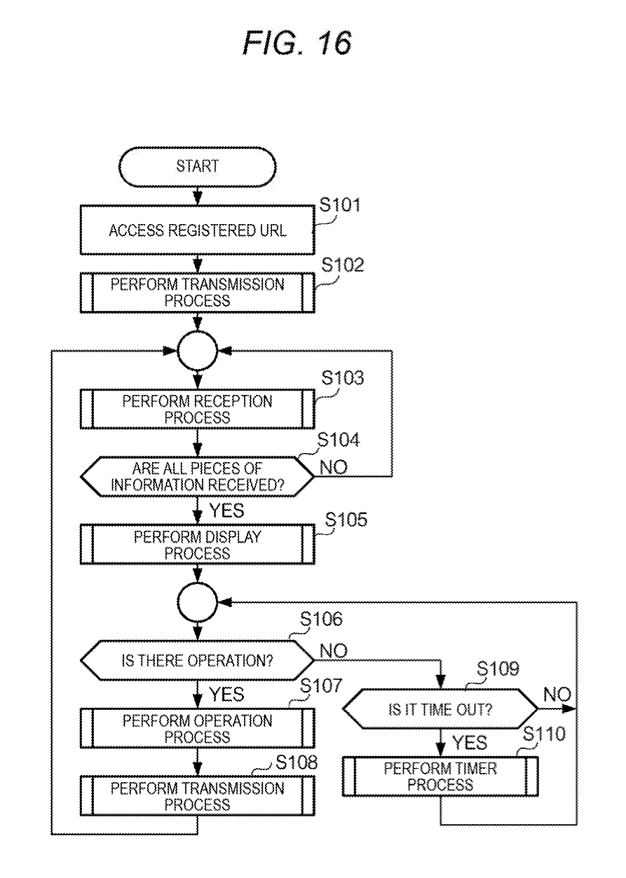

FIG. 16 is a flowchart of a main routine.

<Step S101>

The controller 11 accesses a registered URL. Specifically, the process is as follows.

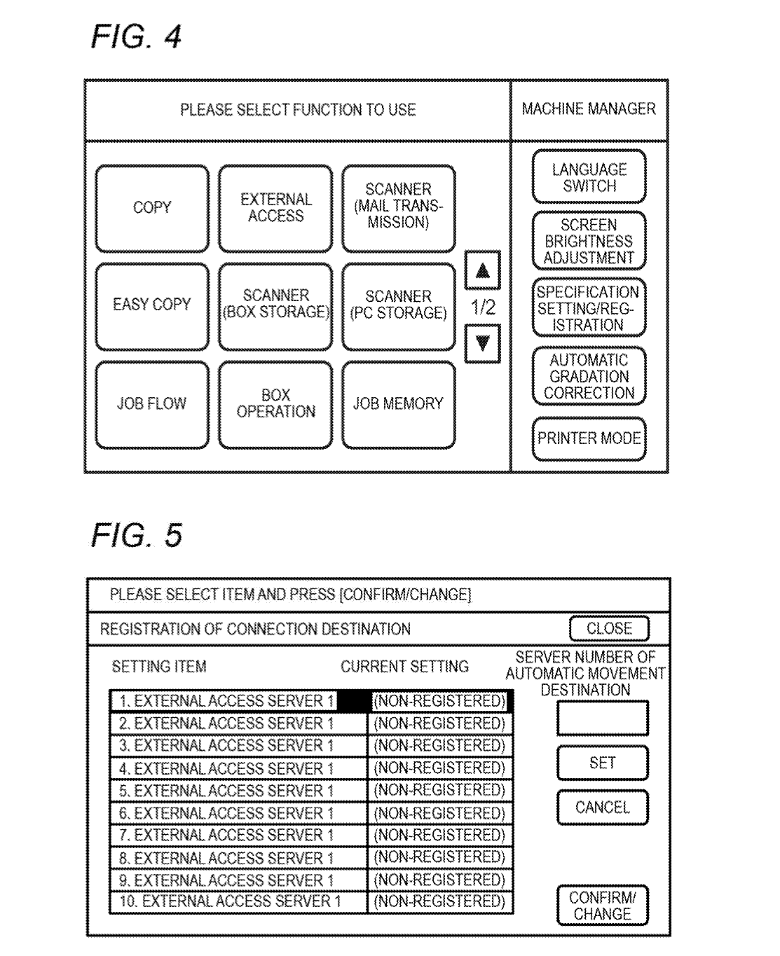

FIG. 4 is a diagram illustrating a menu screen. When the printing device 1 is supplied with power, the menu screen is displayed. When a user operates an “External Access” button of the menu screen, the controller 11 accesses a server registered in the printing device 1. Herein, the description will be made about a registration of an access destination.

FIG. 5 is a diagram illustrating a registration screen. When the user operates a “Specification Setting/Registeration” button of the menu screen, the registration screen is displayed. In the example in the drawing, ten access destinations are registered at a maximum. When any one of the access destination buttons is selected and then a “Setting” button is operated, a setting screen is displayed.

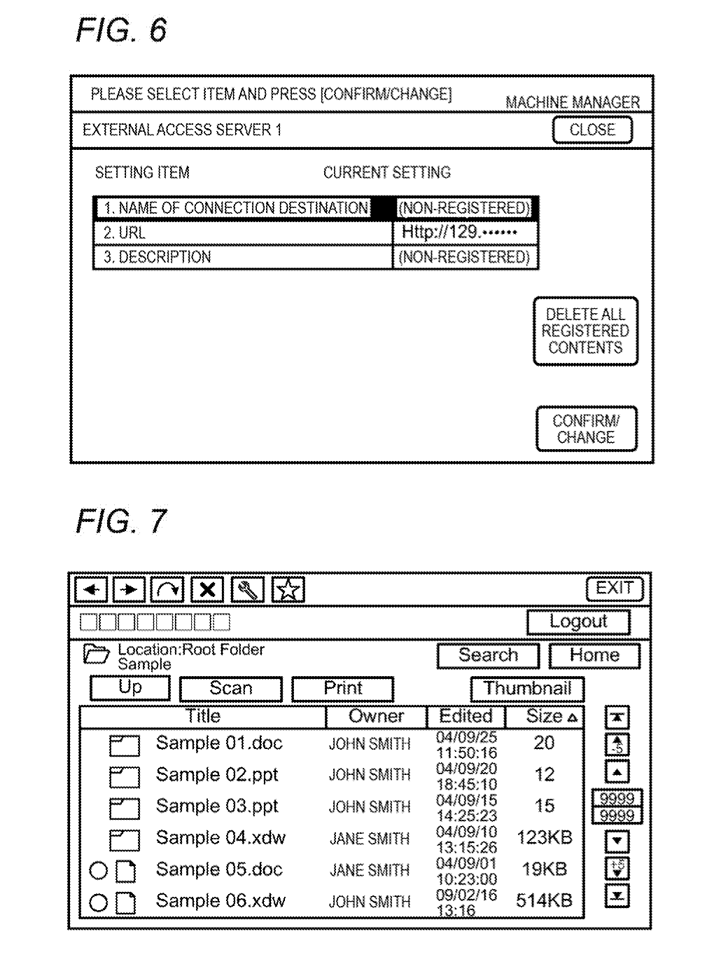

FIG. 6 is a diagram illustrating the setting screen. A URL is selected on the screen, and is registered as an access destination. The above description is a procedure of registering the access destination.

<Step S102>

Next, the controller 11 performs a transmission process.

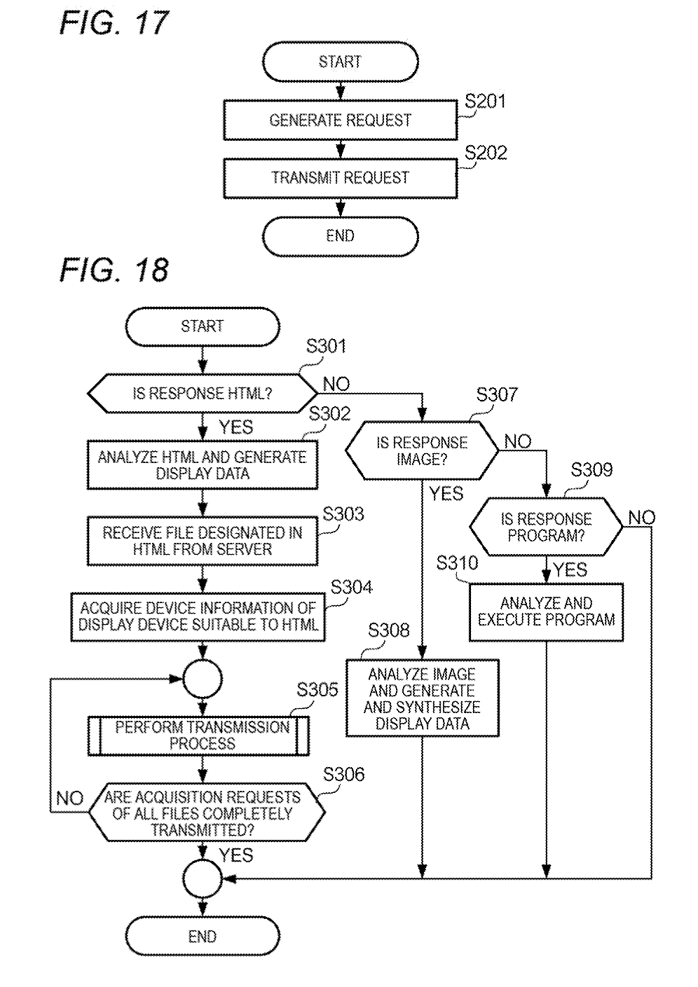

FIG. 17 is a flowchart illustrating the transmission process.

<Step S201>

An HTML file is sent back at the first time from the server 3 to which the controller 11 is accessed. The controller 11 analyses the HTML file, and reads out a URL contained in the HTML file. The controller 11 generates a request of a GET method of an HTTP in which the URL is designated as an acquisition destination of the file. At this time, the controller 11 writes device information (the first device information) of the display 15 in a header of the request. The device information is, for example, information indicating a specification of a display device. Specifically, the device information includes a resolution, a density of pixels, and a size of the display screen. The resolution is expressed by the number of pixels (horizontal resolution) in the horizontal direction×the number of pixels in the vertical direction of the display screen. The density of pixels is expressed by “dpi (dots per inch)” for example. The density in the lateral direction (horizontal dpi) and the density in the vertical direction (vertical dpi) may be equal to each other or not. The size of the display screen is expressed by “inch” for example.

<Step S202>

The controller 11 transmits the generated request to the server 3 (acquisition request).

The above description is a procedure of the transmission process.

The description returns to the main routine (FIG. 16).

<Step S103>

Next, the controller 11 performs a reception process.

FIG. 18 is a flowchart illustrating the reception process.

<Step S301>

At first, the controller 11 receives a response from the server 3, and determines whether the response is the HTML file based on MIME type contained in a header of the received response. In a case where the response is the HTML file (Step S301: YES), the process of the controller 11 proceeds to Step S302. In a case where the response is not the HTML file (Step S301: NO), the process of the controller 11 proceeds to Step S307.

<Step S302>

The controller 11 analyzes the HTML file, and generates display data.

<Step S303>

The controller 11 receives the file designated in the HTML file, from the server 3.

<Step S304>

The controller 11 acquires the device information of the display device, which is suitable to the HTML file, from the header.

<Step S305>

The controller 11 performs the transmission process. The procedure of the transmission process is as described above.

<Step S306>

The controller 11 determines whether the acquisition requests of all the files associated to the HTML file received in Step S301 are completely transmitted. In a case where the transmission is completed (Step S306: YES), the controller 11 ends the reception process. In a case where the transmission is not completed (Step S306: NO), the process of the controller 11 returns to Step S305.

<Step S307>

The controller 51 determines whether the response received from the server 3 is an image based on the MIME type. In a case where the response is an image (Step S307: YES), the process of the controller 11 proceeds to Step S308. In a case where the response is not an image (Step S307: NO), the process of the controller 11 proceeds to Step S309.

<Step S308>

The controller 11 analyses the image received from the server 3, and synthesizes the image with the display data generated by analyzing the HTML file.

<Step S309>

The controller 11 determines whether the response received from the server 3 is a program. The program transmitted from the server 3 is, for example, a program file described by a JavaScript (registered, trademark) language. In a case where the response is a program (Step S309: YES), the process of the controller 11 proceeds to Step S310. In a case where the response is not a program (Step S309: NO), the controller 11 ends the reception process.

<Step S310>

The controller 11 analyzes the program received from the server 3, and performs the program.

The above description is a procedure of the reception process.

The description returns to the main routine (FIG. 16).

<Step S104>

The controller 11 determines whether all the information corresponding to the request transmitted in Step S102 is received. In a case where all the information is received (Step S104: YES), the process of the controller 11 proceeds to Step S105. In a case where there is information not yet received (Step S104: NO), the process of the controller 11 returns to Step S103.

<Step S105>

The controller 11 performs a display process.

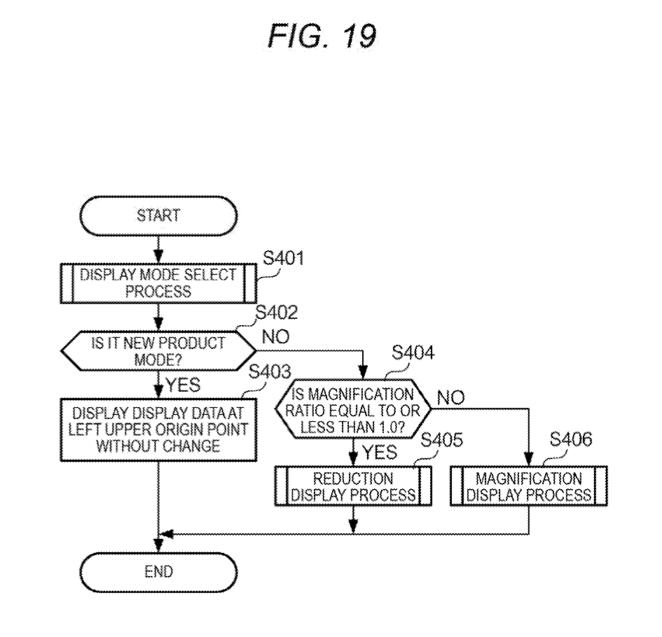

FIG. 19 is a flowchart illustrating the display process.

<Step S401>

The controller 11 performs a display mode select process.

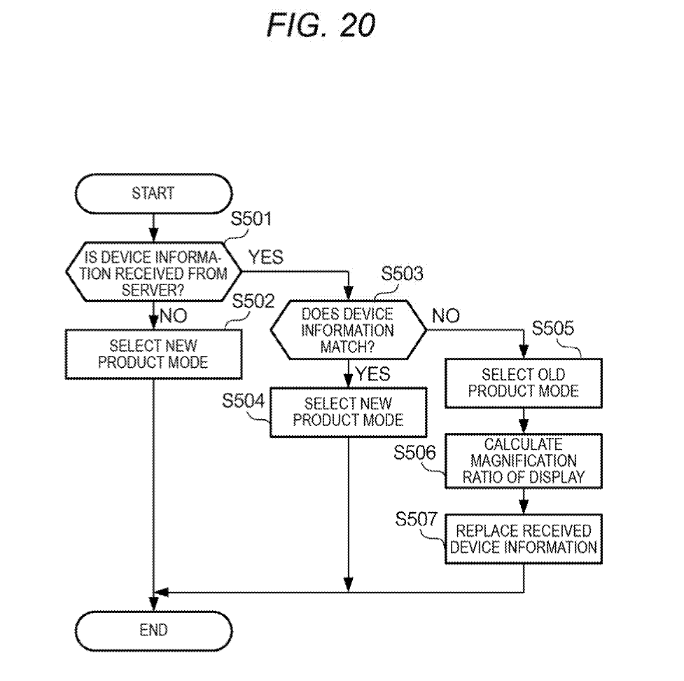

FIG. 20 is a flowchart illustrating the display mode select process.

<Step S501>

The controller 11 determines whether the device information is received from the server 3 based on the presence/absence of the device information (the second device information) in the header of the response. In a case where the device information is not received (Step S501: NO), the process of the controller 11 proceeds to Step S502. In a case where the device information is received (Step S501: YES), the process of the controller 11 proceeds to Step 503.

<Step S502>

The controller 11 selects a new product mode (first mode).

<Step S503>

The controller 11 determines whether the device information of the own apparatus matches the device information received from the server 3. The device information of the own apparatus is the device information written in the header of the request to the server 3 in the transmission process of Step S102. The device information received from the server 3 is the device information read from the header of the response from the server 3 in the reception process of Step S103. In a case where the two pieces of the device information match each other (Step S503: YES), the process of the controller 11 proceeds to Step 504. In a case where the two pieces of the device information do not match each other (Step S503: NO), the process of the controller 11 proceeds to Step S505.

<Step S504>

The controller 11 selects a new product mode (first mode).

<Step S505>

The controller 11 selects an old product mode (second mode).

<Step S506>

The controller 11 calculates a magnification ratio of the display. Specifically, the process is as follows.

(1) Matched in Resolution

For example, a content of a request header is as follows:

display-resolution: 800×480,

display-dpi: 132, and

display-size: 7″ inch.

A content of the response header is as follows:

display-resolution: 800×480,

display-dpi: 103, and

display-size: 9″ inch.

In this case, since the resolutions of the two are equal, 132/103=1.28 becomes the magnification ratio based on the dpi value. Further, this example is an example on an assumption that the pixel is a square type. With this regard, in a case where the pixel is a rectangular type, the following header is provided, and the vertical and horizontal magnification ratios may be separately calculated based on the vertical and horizontal dpi values of the pixel.

display-dpi-x: 103

display-dpi-y: 103

(2) Not Matched in Resolution

In a case where the resolution of the request: header and the resolution of the response header do not match each other, the calculation is performed in consideration of the vertical and horizontal resolutions as follows: Horizontal magnification ratio=Horizontal resolution Of Request header×Vertical dpi/Horizontal resolution of Response header×Vertical dpi, and

Vertical magnification ratio=Vertical resolution of Request header×Horizontal dpi/Vertical resolution of Response header×Horizontal dpi,

<Step S507>

The controller 11 replaces the device information of the own apparatus with the device information received from the server 3. The device information as a rewriting target is window.screen.width which is referred by the JavaScript program received from the server 3, a value such as window.screen.height, and a size of the display screen as a reference of the operation in the @media selector of CSS (Cascading Style Sheets).

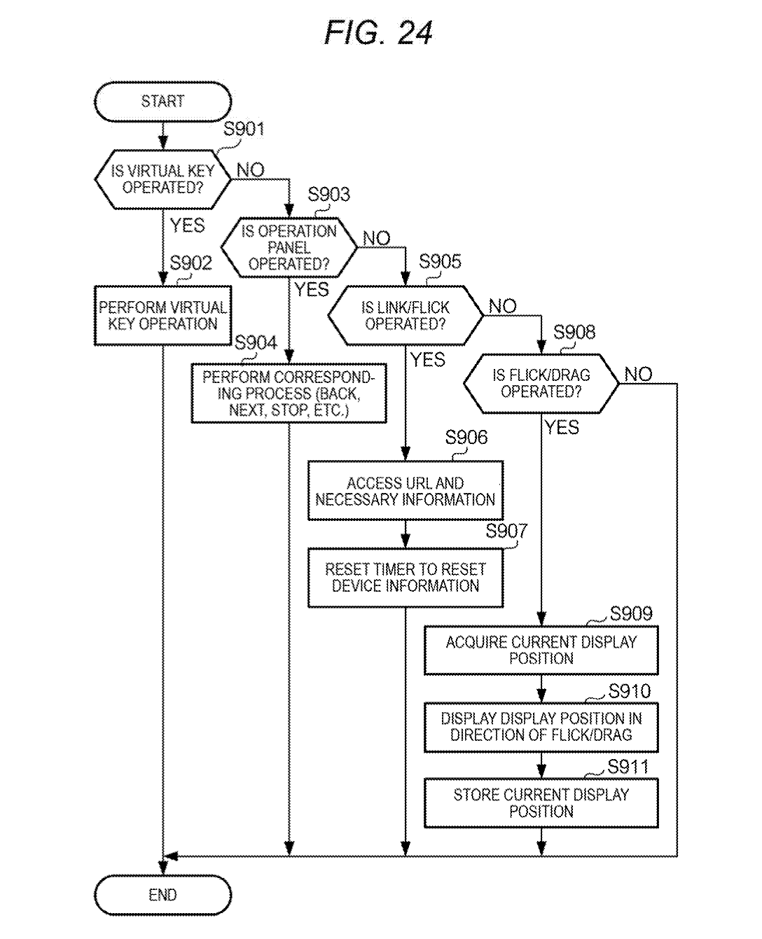

The rewritten device information is reset to the device information of the own apparatus when a link or a form is operated in an operation process described below (FIG. 24).

The above description is a procedure of the display mode select process.

The description returns to the display process (FIG. 19).

<Step S402>

The controller 11 determines whether the mode is the new product mode. In a case where the mode is the new product mode (Step S402: YES), the process of the controller 11 proceeds to Step S403. In a case where the mode is not the new product mode (Step S402: NO), the process of the controller proceeds to Step S404.

<Step S403>

The controller 11 displays the display screen at the left upper corner as the origin without changing the display data.

<Step S404>

The controller 11 determines whether the magnification ratio is equal to or less than 1.0. In a case where the magnification ratio is equal to or less than 1.0 (Step S404: YES), the process of the controller 11 proceeds to Step S405. In a case where the magnification ratio is not equal to nor less than 1.0 (Step S404: NO), the process of the controller 11 proceeds to Step S406.

<Step S405>

The controller 11 performs a reduction display process.

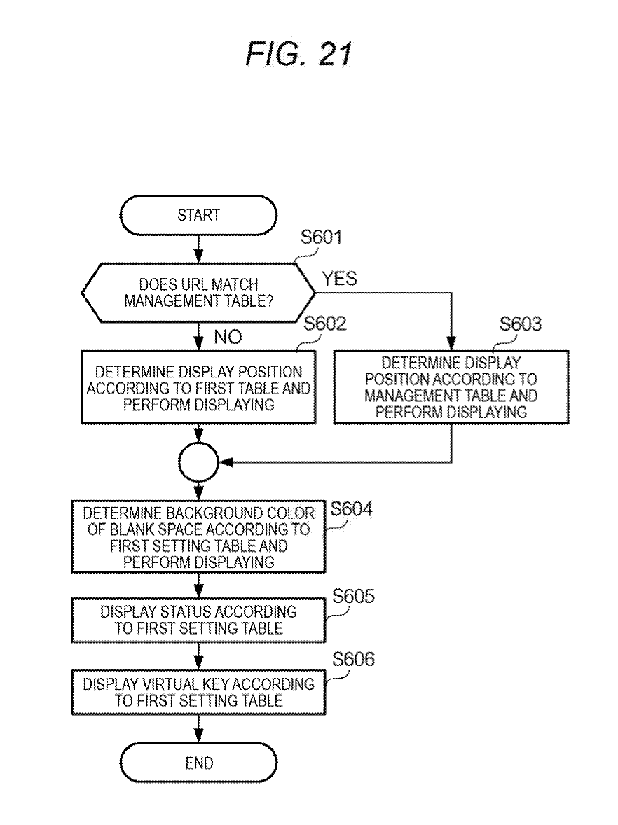

FIG. 21 is a flowchart illustrating the reduction display process.

<Step S601>

The controller 11 determines whether the URL accessed for acquiring the HTML file matches a management table. The URL is a URL which the controller 11 accesses in Step S101.

FIG. 27 is a diagram illustrating the management table. The management table is a table in which the URL of the access destination is associated to a reference position used when the display data based on the information acquired from the URL is displayed. In a case where the accessed URL matches the management table (Step S601: YES), the process of the controller 11 proceeds to Step S603. In a case where the accessed URL does not match the management table (Step S601: NO), the process of the controller 11 proceeds to Step S602.

<Step S603>

The controller 11 determines a display position according to a value of “Position” of the management table, and displays the display data at the display position.

<Step S602>

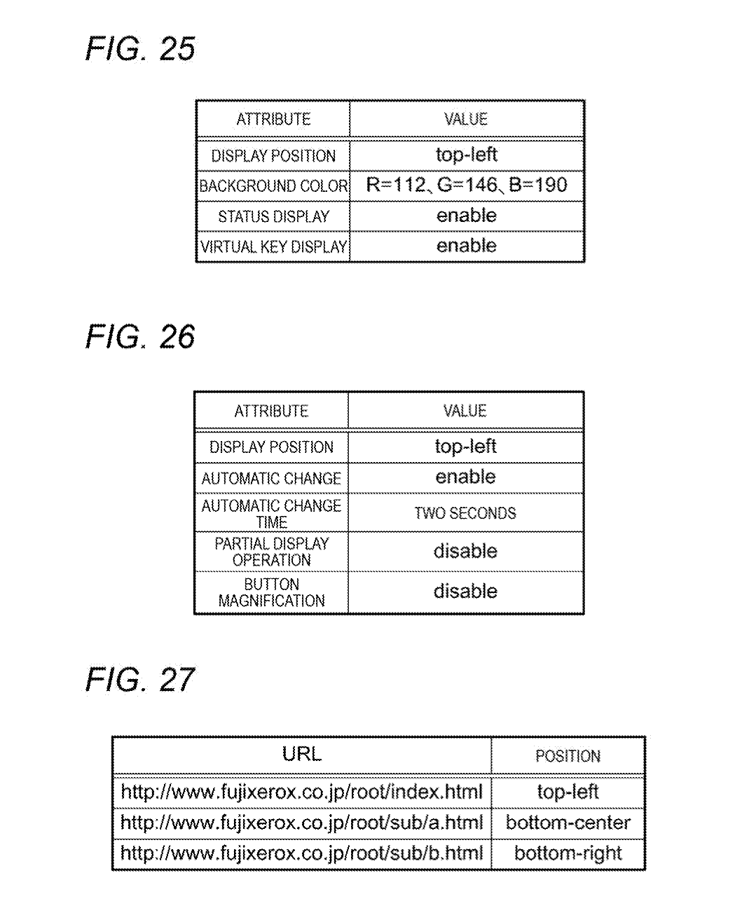

FIG. 25 is a diagram illustrating a first setting table. The first setting table stores a value for designating the display position in a case where the URL does not match the management table. The controller 11 determines the display position according to a value of “Display Position” of the first setting table (in this example, top-left), and displays the display data at the display position.

<Step S604>

The controller 11 determines a background color of a blank space according to a value of “Background Color” of the first setting table (in this example, R=112, G=146, and B=190), and displays the background color.

<Step S605>

The controller 11 displays a status according to a value of “Status Display” of the first setting table. In this example, the value is set to “enable”. Therefore, information, indicating the status of the printing device is displayed at a position of the blank space. In a case where the value is not “enable”, the information is not displayed.

<Step S606>

The controller 11 displays the virtual key according to a value of “Virtual Key Display” of the first setting table. In this example, the value is set to “enable”. Therefore, ten keys for inputting an instruction to the printing device are displayed. In a case where the value is not “enable”, the information is not displayed.

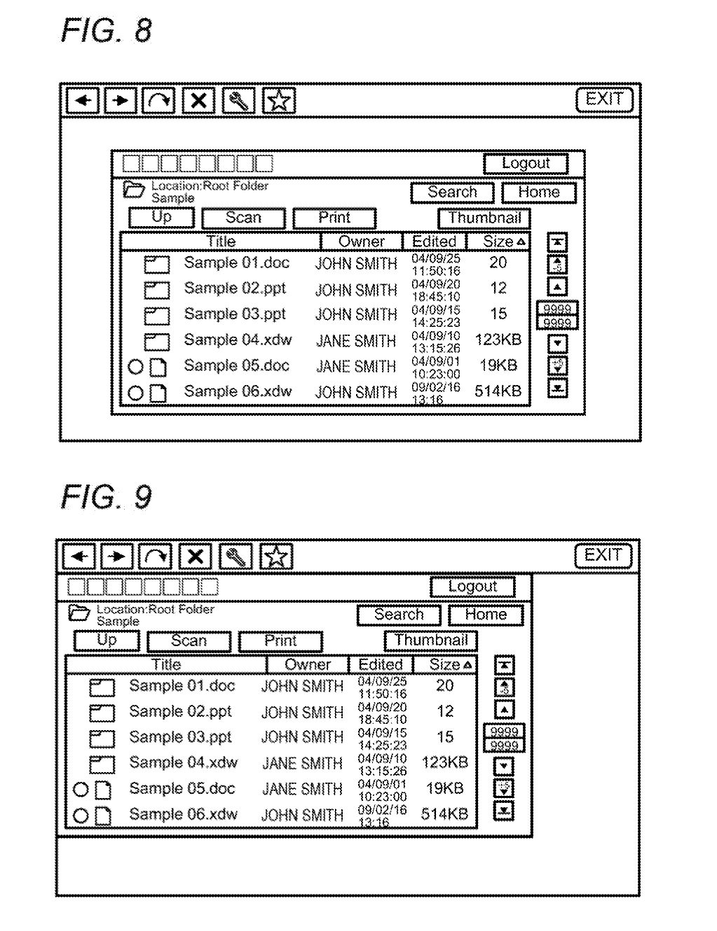

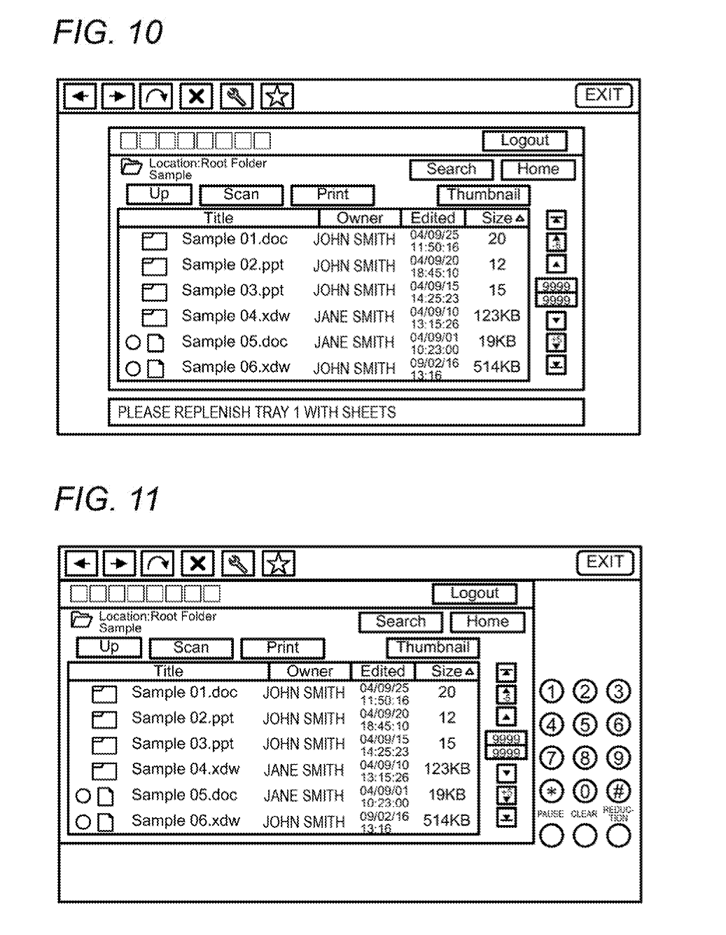

FIG. 8 is a display example in a vase where the display position is at the center. FIG. 9 is a display example in a case where the display position is in a left upper portion. FIG. 10 is a display example showing a status of the device. FIG. 11 is a display example of the virtual key.

The above description is a procedure of the reduction display process.

The description returns to the display process (FIG. 19).

<Step S406>

The controller 11 performs a magnification display process.

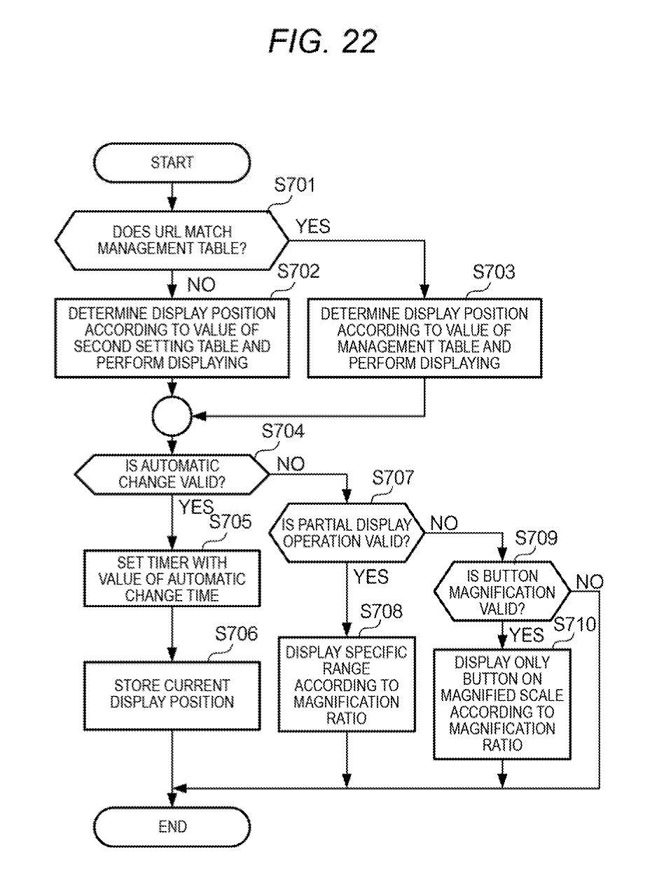

FIG. 22 is a flowchart illustrating the magnification display process.

<Step S701>

The controller 11 determines whether the URL accessed for acquiring the HTML file matches a management table. The URL is a URL which the controller 11 accesses in Step S101. In a case where the accessed URL matches the management table (Step S701: YES), the process of the controller 11 proceeds to Step S703. In a case where the accessed URL does not match the management table (Step S701: NO), the process of the controller 11 proceeds to Step S702.

<Step S703>

The controller 11 determines the display position according to the value of the management table and performs the displaying.

<Step S702>

FIG. 26 is a diagram illustrating a second setting table. The second setting table stores a value for designating the display position in a case where the URL does not match the management table. The controller 11 determines the display position according to a value of “Display Position” of the first setting table (in this example, top-left), and displays the display data at the display position.

<Step S704>

The controller 11 determines whether a value of “Automatic Change” of the second setting table is set to “enable”. In a case where the value is set to “enable” (Step S704: YES), the process of the controller 11 proceeds to Step 705. In a case where the value is not set to “enable” (Step S704: NO), the process of the controller 11 proceeds to Step S707.

<Step S705>

The controller 11 sets a timer with the value of the automatic change time. The determination on timer out will be described below (Step S109 of the main routine).

<Step S706>

The controller 11 stores the current display position.

<Step S707>

The controller 11 determines whether a value of “Partial Display Operation” of the second setting table is set to “enable”. In a case where the value is set to “enable” (Step S707: YES), the process of the controller 11 proceeds to Step 708. In a case where the value is not set to “enable” (Step S707: NO), the process of the controller 11 proceeds to Step S709.

<Step S708>

The controller 11 displays a specific range of the display data which is magnified according to the magnification ratio.

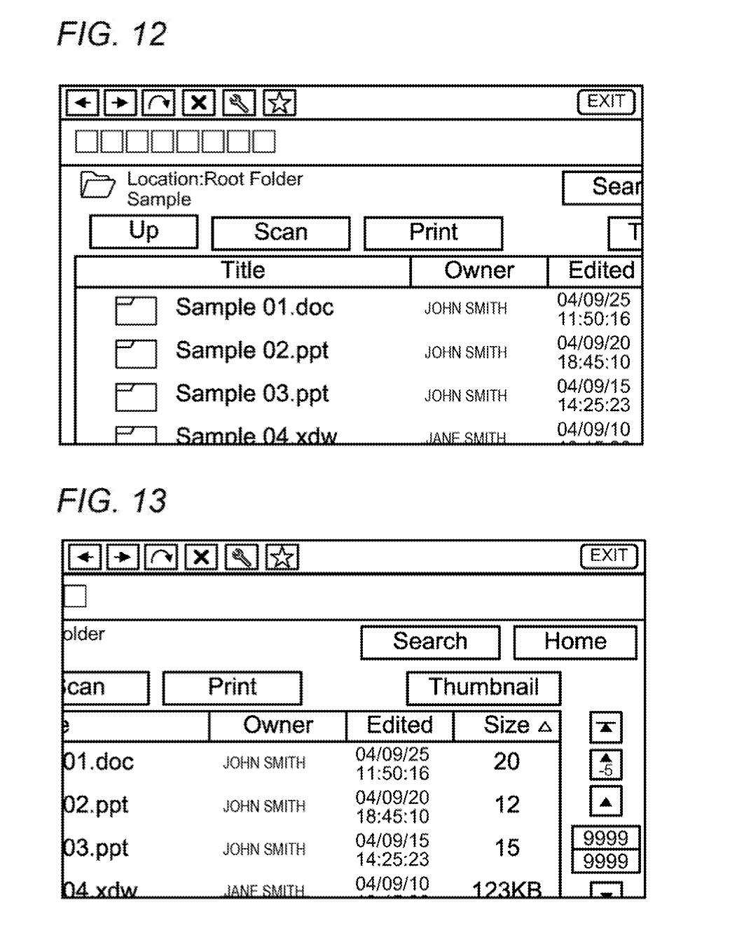

FIG. 12 is an example of a magnified display. FIG. 13 is an example in which the display position is moved by a drag or flick operations.

<Step S709>

The controller 11 determines whether a value of “Button Magnification” of the second setting table is set to “enable”. In a case where the value is set to “enable” (Step S709: YES), the process of the controller 11 proceeds to Step 710. In a case where the value is not set to “enable” (Step S709: NO), the controller 11 ends the magnification display process.

<Step S710>

The controller 11 displays only the button on a magnified scale according to the magnification ratio.

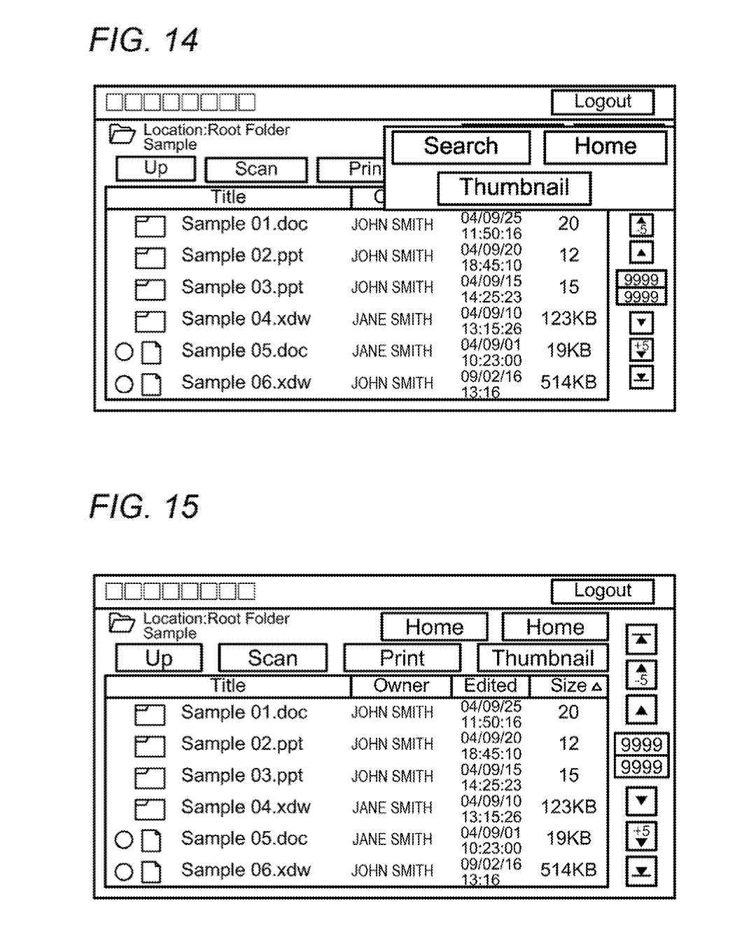

FIG. 14 is a diagram illustrating an example in which the button is displayed on a magnified scale. In this example, the buttons (the virtual operation elements such as Search, Home, and Thumbnail) are displayed on a magnified scale according to the magnification ratio, and the other portions are displayed without being magnified. An event such as a breaking in the layout or a hiding of surrounding portions of the buttons is allowed, and the operability of the buttons is considered in priority.

FIG. 15 is a diagram illustrating another example where the buttons are displayed on a magnified scale, in this example, the buttons (Up, Scan, Print, Search, Home, and Thumbnail) are displayed on a magnified scale according to the magnification ratio, and the gap between the buttons is narrowed.

The above description is a sequence of the magnification display process.

The description returns to the main routine (FIG. 16). <Step S106>

The controller 11 determines whether the receiving unit 16 receives an operation. In a case where an operation is received (Step S106: YES), the process of the controller 11 proceeds to Step S107. In a case where an operation is not received (Step S106: NO), the process of the controller 11 proceeds to Step S109.

<Step S107>

The controller 11 performs the operation process.

FIG. 24 is a flowchart illustrating the operation process.

<Step S901>

The controller 11 determines whether the virtual key is operated. In a case where the virtual key is operated (Step S901: YES), the process of the controller 11 proceeds to Step S902. In a case where the virtual key is not operated (Step S901: NO), the process of the controller 11 proceeds to Step S903.

<Step S902>

The controller 11 performs an operation according to an operated virtual key.

<Step. S903>

The controller 11 determines whether an operation panel is operated.

FIG. 7 is a diagram illustrating an operation screen. Examples of the operation panel include “Back”, “Next”, and “Stop” buttons which are provided on the uppermost of the operation screen. In a case where the operation panel is operated (Step S903: YES), the process of the controller 11 proceeds to Step S904. In a case where the operation panel is not operated (Step S903: NO), the process of the controller 11 proceeds to Step S905.

<Step S904>

The controller 11 performs a process corresponding to the operation of the operation panel (Back, Next, and Stop).

<Step S905>

The controller 11 determines whether a link operation or a form operation is performed. The link operation is an operation on a button associated to the link destination URL. The form operation is an operation on a button to display a window for an input form which is displayed at the end of the button associated to the link destination URL. In a case where the link operation or the form operation is performed (Step S905: YES), the process of the controller 11 proceeds to Step S906. In a case where the link operation or the form operation is not performed (Step S905: NO), the process of the controller 11 proceeds to Step S908.

<Step S906>

The controller 11 accesses the URL in association to the link operation or the form operation.

<Step S907>

The controller 11 resets the device information to the device information of the own apparatus, and resets the timer. The timer is set in Step S705 of the magnification display process (FIG. 22).

<Step S908>

The controller 11 determines whether the flick operation or the drag operation is performed. In a case where the flick operation or the drag operation is performed (Step S908: YES), the process of the controller 11 proceeds to Step S909. In a case where the flick operation or the drag operation is not performed (Step S908: NO), the controller 11 ends the operation process.

<Step S909>

The controller 11 acquires the current display position.

<Step S910>

The controller 11 displays the display position in a direction of the flick operation or the drag operation.

<Step S911>

The controller 11 stores the current display position.

The above description is a procedure of the operation process.

The description returns to the main routine (FIG. 16).

<Step S108>

The controller 11 performs the transmission process. The procedure of the transmission process is as described above.

<Step S109>

The controller 11 determines whether it is a time out. The timer is set in Step S705 of the magnification display process (FIG. 22).

<Step S110>

The controller 11 performs a timer process.

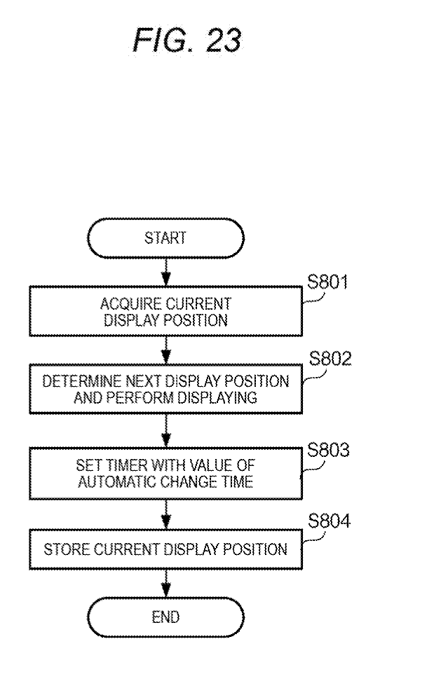

FIG. 23 is a flowchart of the timer process.

<Step S801>

The controller 11 acquires the current display position.

<Step S802>

The controller 11 determines the next display position and performs the displaying. The display position is repeatedly changed such as top-left>top-right>bottom-right>bottom-left>top-left> . . . .

<Step S803>

The controller 11 refers to the second setting table, and sets the timer to a time corresponding to the value of “Automatic Change Time”.

<Step S804>

The controller 11 stores the current display position.

The above description is a procedure of the timer process.

Hitherto, the description has been made about the functional configuration of the exemplary embodiment. It may be considered that information indicating a size of the display screen of a client's electronic apparatus is acquired, and the display data corresponding to the size is created by the server and transmitted to the electronic apparatus. However, in a case where there appears an electronic apparatus having the display screen of which the size is different from the existing apparatus, a software configuration of the server is necessarily changed. Alternatively, it may be considered that a software configuration in which various sizes are taken into considered is established in the server. However, the configuration becomes complicated. According to this exemplary embodiment, there is no need to take trouble such a complicated work.

The above-described exemplary embodiment may be modified as follows. Plural modifications may be combined with each other.

The invention may be applied to an electronic apparatus other than the printing device.

An illumination unit, a recording unit, and a validation unit may be provided in the outside of the electronic apparatus.

In short, the invention may be also specified as an information processing system, which includes an collation unit which collates biometric information acquired from a user with reference information registered in advance, a memory which stores an access of the user who is successful in collation by the collation unit, an execution unit which performs a determined process, and a validation unit which validates a function selected from, the functions of the memory and the execution unit based on the number of times of collation of the biometric information for each user in a determined time period.

The exemplary embodiment has been described, about an example in which the above-described functions are realized by the application program. Some or all of the above-described functions may be installed in a hardware circuit. In addition, the application program may be recorded and provided using a computer-readable recording medium such as an optical recording medium or a semiconductor memory. The program may be installed by being read out of the recording medium and installed. Furthermore, the program may be provided through a telecommunication line.

The foregoing description of the exemplary embodiments of the present invention has been provided for the purposes of illustration and description, it is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An electronic apparatus, comprising:
a display that displays a file;
a communication unit that acquires the file; and
a processor configured to adjust a size of a screen on the display based on first device information for the display and second device information for displaying the file,
wherein the processor adjusts the size of the screen by calculating a magnification ratio of the display based on magnification information included in the first device information and magnification information included in the second device information.

2. The electronic apparatus according to claim 1, wherein in a case where the size of the displayed screen is reduced, the processor displays the screen at a predetermined display position on the display.

3. The electronic apparatus according to claim 2,
wherein in a case where the size of the displayed screen is reduced, the unit processor displays a status of an own apparatus in a blank space of the screen.

4. The electronic apparatus according to claim 2,
wherein in a case where the size of the displayed screen is reduced, the processor displays a virtual panel to operate an own apparatus in a blank space of the screen.

5. The electronic apparatus according to claim 1,
wherein in a case where the size of the displayed screen is magnified, the processor magnifies a size of only an operation element included in the screen.

6. The electronic apparatus according to claim 1,
wherein in a case where the size of the displayed screen is magnified, the processor displays a portion not displayed on the screen by changing a display position of the screen with the lapse of time.

7. The electronic apparatus according to claim 1,
wherein in a case where the first device information does not match the second device information, the processor replaces the first device information with the second device information.

8. The electronic apparatus according to claim 1,
wherein in a case where the first device information matches the second device information, the processor does not adjust the size of the displayed screen.

9. The electronic apparatus according to claim 1,
wherein in a case where the second device information is not acquired, the processor does not adjust the size of the displayed screen.

10. A non-transitory computer readable medium storing a program causing a computer of an electronic apparatus to execute a process, the electronic apparatus comprising a display and a communication unit, the process comprising:
in response to the communication unit acquiring a file,
adjusting a size of a screen on the display based on first device information for the display and second device information for displaying the acquired file by calculating a magnification ratio of the screen based on magnification information included in the first device information and magnification information included in the second device information, and
displaying the file on the display with the adjusted screen.

11. The electronic apparatus according to claim 1, wherein the communication unit acquires the second device information with the file.
